(19) United States
(12) Patent Application Publication
(10) Pub. No.: US 2019/0358114 A1
(43) Pub. Date: Nov. 28, 2019

(54) MULTIPURPOSE WALKING ASSIST DEVICE FOR MEDICAL THERAPEUTIC USE

(71) Applicant: AVROTH, S.L., MADRID (ES)

(72) Inventor: ALEJANDRO ROTH, MADRID (ES)

(21) Appl. No.: 16/196,142

(22) Filed: Nov. 20, 2018

(30) Foreign Application Priority Data
May 24, 2018 (ES) U201800312

(51) Int. Cl. A61H 3/04

(52) U.S. Cl. CPC A61H 3/04; A61H 2003/007; A63B 2225/093; A61H 2201/0161

(57) ABSTRACT

An advanced physiotherapy walking assistant on wheels, reconfigurable for multiple medical rehabilitation and physiotherapy purposes to provide the user with adequate body support in an upright position, and optimal bipedal mobility. The walking assist device is equipped with calibrated helical springs, placed between an adjusting unit for vertical movement screw and the portal frames, thus providing a floating body support instead of a rigid support, in order to thus enable the accompaniment of the vertical thoracic movement resulting from walking, and a readjustment of the level of body support of the patient. The walking assist device comprises a base frame on four castor wheels, an articulatable upper rail frame assembly positioned by means of removable support tubes, assembly or portal frame for pelvic support, an assembly or portal frame for underarm support, and calibrated helical springs supported by two track portals.

### TECHNICAL FIELD

The present invention belongs to the field of the medical-therapeutic industry.

### BACKGROUND OF THE INVENTION

Currently, in the medical state of the art there are different models of rehabilitation devices to be used in therapy for patients with acquired or congenital mobility difficulties and which facilitate a correct bipedal and autonomous posture for the patient. However, current models, since they do not have a modular design, are limited to providing a specific function of bipedal movement in a stiff and non-floating support, which is a desirable element in accompanying the vertical body movement that results when walking.

In current walking assist devices, once the patient is placed in the upright position, there is no possibility of readjusting the body load, due to the fact that the telescopic support requires the assistance of two operators ( ), this limiting operational issue ( ) is solved by the model described herein since it achieves ( ) body support adjustment by means of a centralised screw system (and) that also provides ( ) the possibility of measuring the ( ) body unload magnitude ( ) by the provisions of ( ) a) calibrated measuring scale. Furthermore, (t) the body base frame support on castor wheels of the patient is achieved through a pelvic harness frame and an underarm support tubes that, together with a leg separator, when necessary, enable bipedal mobility in patients with spastic limbs associated with contractures of the joints in the knee, pelvis, etc. as well as associated physiological or neurological damage.

### DESCRIPTION OF THE INVENTION

The invention consists of an advanced walking assistant device on wheels (reconfigurable for multiple medical rehabilitation and physiotherapy purposes) for providing the user with adequate body support in an upright position, and optimal bipedal mobility. The device provides pelvic and underarm support by means of vertically adjustable portal frames, which have a modular design, that is, they are easily removable for achieving multifunctional features.

The walking assist device is equipped with calibrated helical springs, placed between the screw adjusting unit for vertical movement and the portal frames, thus providing a floating body support instead of a rigid support, in order to thus enable the accompaniment of the vertical thoracic movement resulting from walking, as well as the readjustment of the level of body support of the patient, a calibrated scale provides the magnitudes of body weight loading of the user and thereby achieve the personalisation of the features. The upper thoracic armpit portal has horizontally-movable support arms in order to allow it to adapt to the different thorax dimensions.

The structural design of the walking assist device ensures a long useful life, since the structure and complementary elements thereof are manufactured with high strength materials such as 304 stainless steel and 6061 T6 aluminium. The armpit supports of the portals are easily removable and self-adjustable. The rollers of the portal's rails are equipped with internal ball bearings that provide optimum durability.

The central screw unit made of aluminium for the vertical adjustment of the portals is equipped with replaceable threaded bushings made of graphite bronze, which is provided with a machined groove in the form of pulleys in order to enable the use of an adjustment belt for quick vertical movement (complementary element).

The platform of the device which acts as a base is constructed from a rectangular tube. The indoor version rests on four robust castor wheels equipped with brakes, the outdoor version is provided with larger diameter front wheels in order to make it easier to overcome obstacles and are provided with disc brakes, rear castor wheels with brake and suspension. The base frame materials for outdoor use is 6061 T6 aluminium, or equivalent alloy for reduced weight, in order to provide optimal portability.

The walking assist device in all the versions thereof is easily storable and transportable, given that the structure thereof folds on itself, which provides it with a significant additional advantage which is portability and storage thereof by being foldable.

### BRIEF DESCRIPTION OF THE DRAWINGS

As a complement to the description provided herein, and for the purpose of helping to make the characteristics of the invention more readily understandable, a set of drawings is attached as an integral part of said description, which, by way of illustration and not limitation represent the following:

FIG. 1. Shows a general diagonal isometric view of the device of the invention. The entirety of the assemblies that make up the walking assist device can be seen, in an integrated manner and which enables the final appearance and the functional nature thereof to be seen, all of this according to the characteristics of the invention.

FIG. 2. Illustrates a diagonal view of the base frame that acts as a support for the entire upper structural assembly and that in turn is supported on 4 castor wheels, all of this according to the characteristics of the invention.

FIG. 3. Shows a diagonal view of the rail-frame assembly of the device of the invention and on which the respective portals and complements are distributed.

FIG. 4. Illustrates a diagonal view of the pelvic support assembly of the device of the invention, which is what enables the entrance and exit of the user and the fastening thereof through the pelvic harness, all of this according to the characteristics of the invention.

FIG. 5. Shows a diagonal view of the underarm support assembly and track portal of the device of the invention.

FIG. 6. Illustrates a diagonal view of the screw unit for vertical movement of the track portals and helical springs of the device of the invention.

FIG. 7A. Shows a complete and general side view of the device of the invention.

FIG. 7B. Shows a complete and general front view of the device of the invention.

FIG. 8. Shows a general diagonal isometric view of the device of the invention with the removable accessories incorporated.

FIG. 9. Illustrates an image of the spring incorporating a comparative calibrated scale that enables the measuring of the level of body load applied to the user, according to the characteristics of the invention.

FIG. 10. Shows a diagonal isometric view of the device of the invention folded which facilitates transporting and storage.

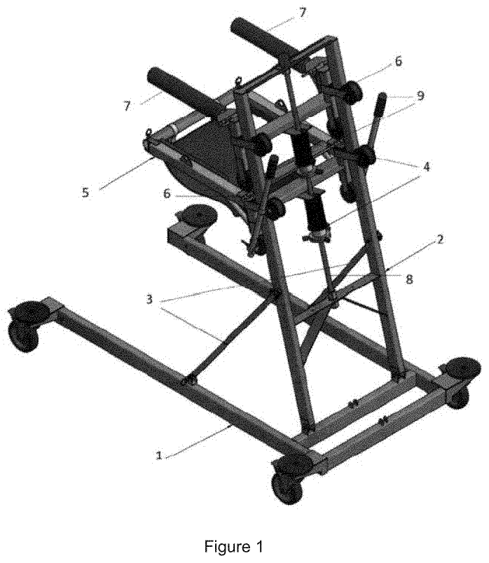

### PREFERRED EMBODIMENT OF THE INVENTION

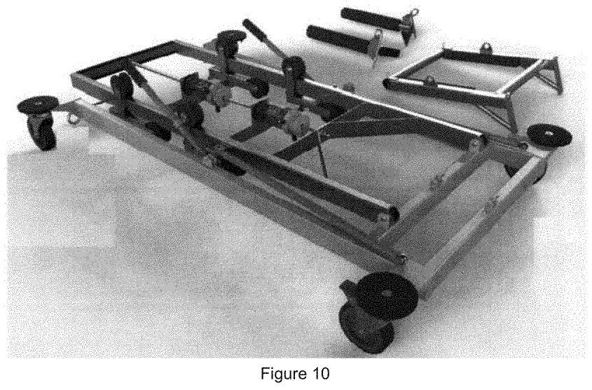

The walking assist device is made up of a frame made of steel, aluminium or other material of high strength and durability (1) equipped with four castor wheels with a brake. This frame acts as a support for the entire upper structural assembly and carries out the function of articulatable rail frame (2), for the respective portals and the complements thereof. It has a pelvic frame (5) and an underarm support frame (7) both supported on corresponding track portals (6), a threaded rod (8) which enables the vertical movement, two screw units with calibrated spring (4) and finally a pair of grip handles (9). This entire assembly is supported in the vertical position thereof by means of two compressed tubular support arms (3), which are further foldable in order to enable the device to fold on itself according to FIG. 10 of the drawings.

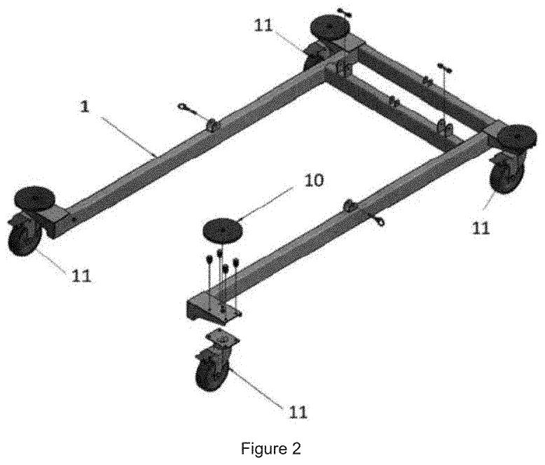

The base support frame (1) illustrated in FIG. 2 is made up of a rectangular tribe made of steel or aluminium material of high strength and durability that provides it with the necessary structural rigidity, and is supported by four castor wheels (11) with an incorporated foot brake (optional directional locking), and four neoprene discs (10) for damping impacts against possible obstacles.

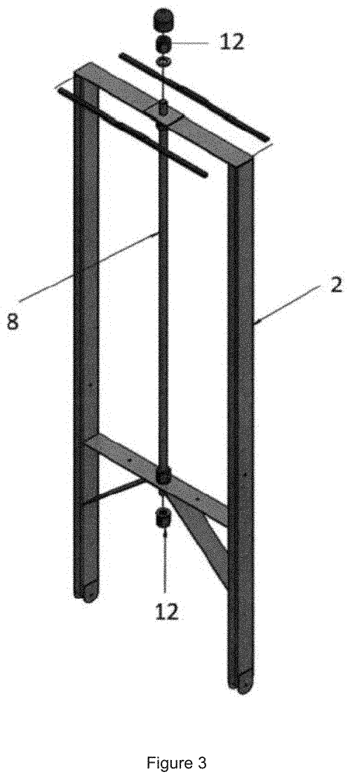

The upper rail frame assembly (2) illustrated in FIG. 3 is made from 304 stainless steel or 6061 T6 aluminium, according to the model, dimensionally precise as far as the parallelism of the rails with regard to each other for the proper operation in the movement of the portals, apart from incorporating a threaded rod piece (8), trapezoidal or square ISO TR16x4 type made of 304 stainless steel, attached on the ends thereof with four fastening screws (12).

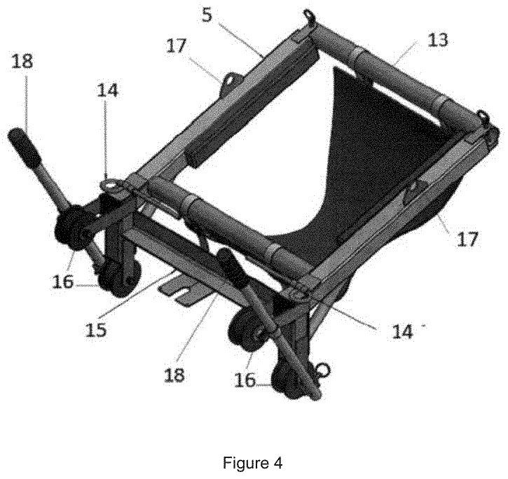

The pelvic support frame assembly illustrated in FIG. 4 has two rectangular support tubes (5) and an incorporated hinged tube (13) in order to enable the entrance and exit of the user, and which further provides the support of the pelvic harness. Said frame is attached by means of removable pins (14) to the track portal (15) equipped with four rollers (16) incorporating bearings with bushings, in order to ensure the operational longevity thereof. It incorporates two perforated sling attachment tabs (17) in order to hook a medical hoist for transferring the user, situated laterally in the centre of gravity thereof. Two tubular handles ending in a cap and neoprene wrapping are fastened on the ends of the track portal in order to facilitate the grip (18), being adjustable to different positions.

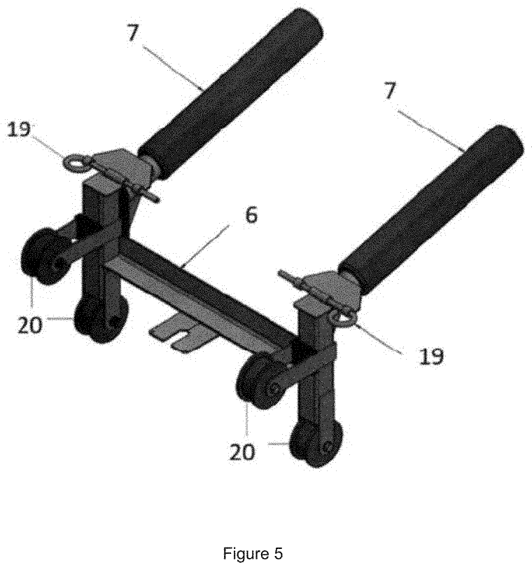

FIG. 5 describes the underarm support assembly that is made up of two tubular arms (7), articulated and removable, which are sleeved with removable neoprene sponge. Said articulated arms move horizontally in order to adapt to different thoracic size are held by means of removable pins (19) to the track portal (6), and equipped with four rollers (20) made of nylon incorporating bearings with bushings, in order to ensure the operational longevity thereof exactly as occurs with the pelvic support.

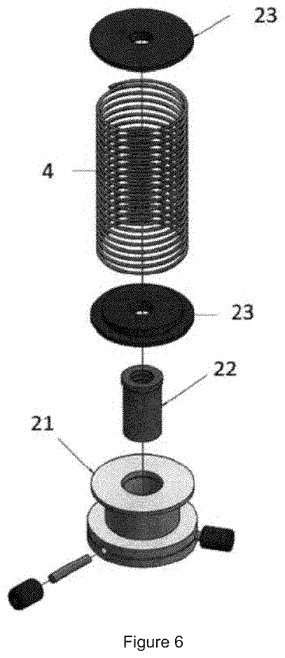

FIG. 6 shows the screw assembly for the vertical movement of the track portals, made up of a 6061 T6 aluminium body (21), and which houses therein the corresponding threaded bushing made of graphite bronze (22), the vertical movement of which is achieved by means of a complementary threaded rod (14). The screw unit for the vertical movement has an incorporated calibrated helical spring (4) made of 321 stainless steel (of 70/80/90 kg), in order to provide the user with the necessary floating support. The spring is equipped on the ends thereof with two separating axial bushings (23) made of nylon in order to prevent friction with the aluminium unit.

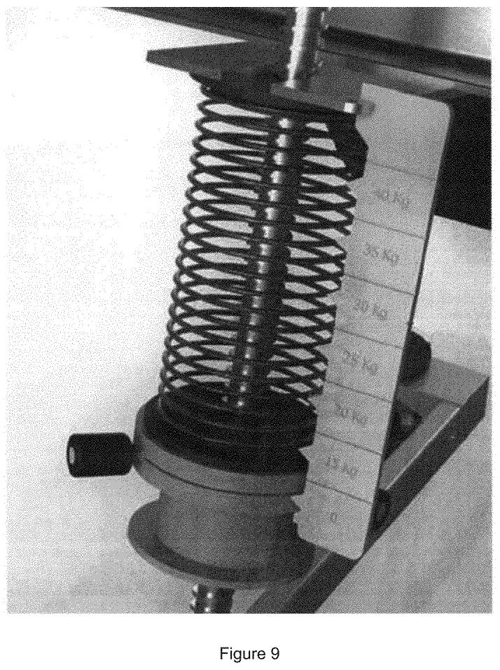

The spring, with a pre-established magnitude, enables, by means of a comparative calibrated scale, the level of body load applied to the user to be measured, as seen in the image of FIG. 9.

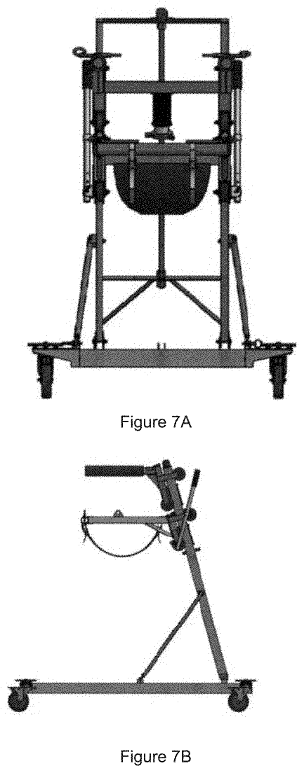

FIG. 7 shows a side elevation view (7A) and a front view (7B) of the device.

The walking assist device with a modular design enables the walker assistant to be reconfigured in order to satisfy multiple functions in the field of rehabilitation.

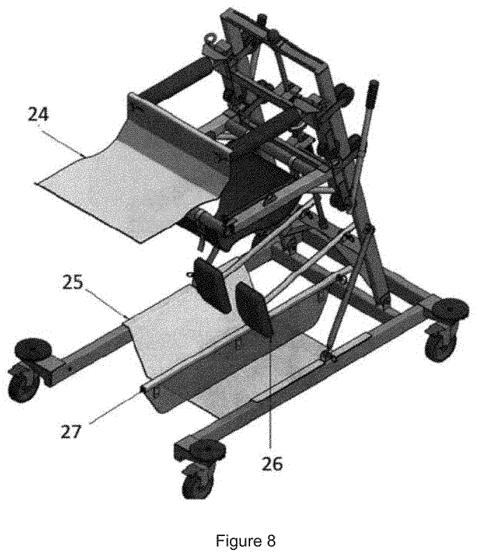

The same walking assist device is adapted for use as a standing frame in paraplegic persons and/or rehabilitation in those that suffer from neurological and physiological damage, the use thereof in geriatrics, as well as a means of body support to prevent subsequent muscular spasticity in persons having undergone simple surgeries, such as appendix, hernias, caesareans, etc. In order to reach the objective multifunction described above, the modular design thereof enables the quick removal of the pelvic and underarm supports, according to the medical function desired. The accessories that complement it and that enable the walking assist device to be reconfigured as a standing frame according to the medical requirements for each user are seen in the isometric view of FIG. 8, these being the removable supporting platform table (24), foot support platform (25), the articulated knee supports (26) and the foot separator (27).

Another functional alternative of the device enables electric motors to be incorporated for the autonomous movement of the patient, controlled by means of a control lever.

1. A multipurpose walking assist device for medical-therapeutic use, comprising a device with reconfigurable modular design for bipedal assistance, a base frame on four castor or fixed front wheels, an articulatable upper rail frame assembly positioned by means of removable compressed support tubes and foldable on itself, an assembly or portal frame for pelvic support with a handle for gripping, an assembly or portal frame for underarm support, both integrated in a threaded rod with the respective screw units and calibrated helical springs thereof, supported by two track portals.

2. The multipurpose walking assist device for medical-therapeutic use, according to claim 1, wherein the base frame constructed from a rectangular tube made of steel, aluminium or another material with high strength and durability, arranged on four castor wheels, the back two with an incorporated foot brake and the front ones with direction locking and four impact discs made of neoprene.

3. The multipurpose walking assist device for medical-therapeutic use, according to claim 1, wherein the upper rail frame assembly incorporates a threaded rod piece, attached on the ends thereof with four fastening screws.

4. The multipurpose walking assist device for medical-therapeutic use, according to claim 1, wherein the pelvic frame assembly has two rectangular support tubes, a hinged articulated tube, further provided with two attachment tabs on both sides, perforated and located on the outer ends of the frame, which is attached to the track portal by means of removable pins, and it incorporates on the ends thereof two tubular handles and four rollers with bushings made of graphite bronze or bearings.

5. The multipurpose walking assist device for medical-therapeutic use, according to claim 1, comprising two tubular arms for underarm support, articulated and removable, sleeved with neoprene sponge or a similar material, movable horizontally, and attached by means of removable pins to the track portal, and equipped with four rollers, incorporating bushings made of graphite bronze or bearings.

6. The multipurpose walking assist device for medical-therapeutic use, according to claim 1, wherein the screw assembly comprises a threaded rod which integrates two assemblies of height adjusters through the centre thereof made up of an aluminium body, each one equipped on the inside thereof with a threaded bushing made of graphite bronze, and calibrated helical springs incorporating two separating axial bushing discs on each end and a comparative calibrated scale.

7. The multipurpose walking assist device for medical-therapeutic use, according to claim 1, comprises, as optional and separately removable accessories, a supporting platform, articulated knee supports, a foot support platform and a foot separator element.
